(19) United States
(12) Patent Application Publication
(10) Pub. No.: US 2021/0291718 A1
(43) Pub. Date: Sep. 23, 2021

(54) Magneized RV Pads

(71) Applicant: Daniel L. Thompson, Lindale, TX (US)

(72) Inventor: Daniel L. Thompson, Lindale, TX (US)

(21) Appl. No.: 17/207,680

(22) Filed: Mar. 21, 2021

Related U.S. Application Data
(60) Provisional application No. 62/992,284, filed on Mar. 20, 2020.

(51) Int. Cl. B60P 3/36; B60S 9/04

(52) U.S. Cl. CPC B60P 3/36; B60S 9/04

(57) ABSTRACT

A magnetized pad designed to significantly provide a larger footprint for the vehicle's jack foot is disclosed. The magnetized pad is configured to provide a larger footprint for the leveling jacks to stabilize and level the vehicle, for example, the recreational vehicle (RV). Each magnetized pad comprises one or more pockets, which are partially filled with an adhesive. One or more magnets are securely and adhesively disposed into each pocket of the magnetized pad. The magnets are configured to securely hold the leveling jack during operation. A protective layer or a disc is pressed onto each pocket so the upper surface of the protective layer is level with the top surface of the magnetized pad. The bottom of each magnetized pad features a tread-like surface for assuring a good grip on smooth surfaces or grounds.

### BACKGROUND OF THE INVENTION

### A. Technical Field

The present invention generally relates to jack pads. More specifically, the present invention relates to magnetized pads designed to significantly provide a larger footprint for the vehicle's jack foot for leveling and stabilizing a vehicle, for example, a recreation vehicle (RV).

### B. Description of Related Art

One of the earliest known recreational vehicles (RVs) in the United States is the horse-drawn covered wagon, which played a significant role in populating the interior of the North American continent. The wagons were used to house traveling peoples usually associated with shows and circus performers. The introduction of the automobile has created a significant improvement in the RVs including motorhomes, travel trailers, camper trailers, fifth-wheel trailers, and other recreational vehicles. Further, several types of RVs have fashioned from various materials.

The early automobiles were low powered and not capable of towing much weight. Later, the automobile bodies were constructed with RVs to create dedicated motorhomes or RVs. These RVs had to be a sturdy structure to endure uneven roads or passages. By the 1920s, the RV was well established in the United States. Besides, camping clubs were established across the country, despite the unpaved roads and minimal camping facilities. Later, several manufacturers began construction on house trailers or trailer coaches. During the 1950s, the RV industry was closely associated with the mobile home industry due to the limited size of the mobile home at that time. The 1950s witnessed the separation of these two industries, and RV manufacturers began developing and marketing their self-contained motorhomes or RV trailers.

Setting up a recreational vehicle requires several procedures, including power, sewer, and leveling, once the user has settled on a spot to make camp. One of the most crucial aspects of setting up a recreational vehicle is to get the vehicle level. There is nothing more uncomfortable than an RV that is uneven. Sewer and water systems will not work correctly as well as many other services on which people depend.

The manufacturers of RVs have included a set of leveling jacks on the underneath side of the RV, usually at 4 points. The jack is manually expanded to level the RV by a person, although a more expensive version can be done automatically. In many camping spots, the designated RV area is not paved or only gravel or some other soft surface. Currently, when the travel trailer is pulled into a campsite, the leveling jacks, one at each corner, are lowered until they touch the campsite's surface. The ground at campsites may vary from gravel pads, concrete or asphalt pads, and soft surfaces such as grass or sand. If the ground is of a loose or soft surface, the leveling process of the RV may have to be performed every few hours as the jack's foot compresses the surface as people move around in the trailer or the wind rocks it. Many people improvise with wood or other materials with varying degrees of success. However, sinking of jacks' foot into the soft surface on which leveling is attempted not only damages the surface but also poses a safety hazard to the user.

Currently, when a trailer is pulled into a campsite, the leveling jacks, one at each corner, are lowered until they touch the campsite's surface. If the site is of loose or soft material, the leveling process may have to be performed every few hours as the jack's foot compresses the surface as people move around in the trailer or the wind rocks it. This could be an irritating problem.

In light of the above-mentioned problems, there is a need for magnetized pads designed to significantly provide a larger footprint for the vehicle's jack foot for leveling and stabilizing a vehicle, for example, the recreational vehicle.

### SUMMARY OF THE INVENTION

The present invention generally discloses jack pads. Further, the present invention discloses magnetized pads designed to significantly provide a larger footprint for the vehicle's jack foot for leveling and stabilizing a vehicle, for example, a recreation vehicle (RV).

In one embodiment, the magnetized pad is configured to provide a larger footprint for the leveling jacks to stabilize and level the vehicle, for example, the recreational vehicle (RV). In one embodiment, the magnetized pad could be designed with different dimensions and sizes to accommodate the much heavier vehicles, for example, motor-home type of RVs. In one embodiment, the bottom of each magnetized pad features a tread-like surface for assuring a good grip on different surfaces or grounds. In one embodiment, the vehicle could be, but not limited to, a camper, a trailer, fifth wheel, toy hauler or motor home. In one embodiment, interlocking chocks could be used for safely blocking wheels of the vehicle. The interlocking chocks are positioned at the wheels of the vehicle. In one embodiment, one or more magnets could be embedded in the interlocking chocks for securing the interlocking chocks together as a block.

In one embodiment, the leveling jack lower portion is securely positioned on a top surface of the magnetized pad and the upper portion is securely attached to the underside of the vehicle. The magnetized pad could be used for any type of leveling jacks. In one embodiment, the magnetized pad comprises one or more magnets. In one embodiment, the magnets could be embedded into, but not limited to, the top surface of the magnetized pad. The magnets are configured to securely hold the leveling jack during operation. In an exemplary embodiment, the magnets could be, but not limited to, strong neodymium magnets.

The deployment of the magnetized pad is very easy and quick, and prevents the leveling jacks from sinking into soft surfaces or grounds. In one embodiment, the magnetized pad could be made of a material, but not limited to, plastic. In an exemplary embodiment, the magnetized pad could be made of, but not limited to, high-density polyethylene (HDPE) plastic.

In one embodiment, each magnetized pad comprises one or more pockets, which are partially filled with an adhesive. The magnets are securely and adhesively disposed into each pocket. In one embodiment, the adhesive such as, but not limited to, 2-part epoxy adhesive. In one embodiment, a protective layer or a disk is pressed onto each pocket so the upper surface of the disk is level with the top surface of the magnetized pad. In one embodiment, the disk is made of, but not limited to, high-density polyethylene (HDPE) plastic.

In one embodiment, the bottom portion of the magnetized pad comprises a bottom surface with a tread-like pattern. The bottom surface could prevent the magnetized pad from slipping on smooth surfaces or grounds. In some embodiments, the bottom surface of the magnetized pad includes, but not limited to, one or more machined multiple patterns to prevent slippage upon gravel or loose soil surface.

In one embodiment, the cylindrical structure could be placed at the bottom portion of the magnetized pad to obtain more height in circumstances of very uneven terrain. In one embodiment, the cylindrical structure comprises one or more plurality of light-emitting diodes (LEDs) to provide lighting for the user in low light conditions. In one embodiment, the LEDs could be, but not limited to, pressure sensitive LEDs.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a perspective view of magnetized pads used for stabilizing and leveling a vehicle, for example, a recreational vehicle, in an embodiment of the present invention.

FIG. 2 shows a perspective view of a leveling jack positioning on the magnetized pad in one embodiment of the present invention.

FIG. 3 shows a perspective view of a leveling jack securely positioning on a top surface of the magnetized pad in one embodiment of the present invention.

FIG. 4 shows a perspective view of the magnetized pad provided with one or more magnets in one embodiment of the present invention.

FIG. 5 shows a perspective view of a bottom portion of the magnetized pad in one embodiment of the present invention.

FIGS. 6-7 show perspective views of interlocking chocks in one embodiment of the present invention.

FIG. 8 shows a perspective view of the interlocking chocks secured together as a block in one embodiment of the present invention.

FIG. 9 shows a perspective view of a cylindrical structure used for increasing the height of a vehicle at very uneven terrain in one embodiment of the present invention.

FIG. 10 shows a top view of the magnetized pad in one embodiment of the present invention.

FIG. 11 shows a side view of the magnetized pad in one embodiment of the present invention.

FIG. 12 shows a sectional view of the magnetized pad in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

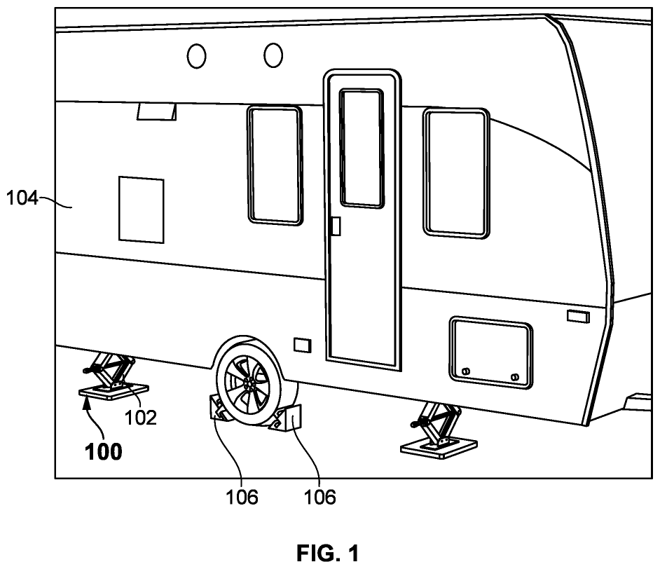

Referring to FIG. 1, a magnetized pad 100 used along with leveling jacks 102 for stabilizing and leveling a vehicle 104, in one embodiment of the present invention is disclosed. In one embodiment, the magnetized pad 100 is configured to provide a larger footprint for the leveling jacks 102 to stabilize and level the vehicle 104, for example, the recreational vehicle (RV). In one embodiment, the magnetized pad 100 could be designed with different dimensions and sizes to accommodate the much heavier vehicles, for example, motor-home type of RVs. In one embodiment, the bottom of each magnetized pad 100 features a tread-like surface for assuring a good grip on different surfaces or grounds. In one embodiment, the vehicle 104 could be, but not limited to, a camper, a trailer, fifth wheel, toy hauler or motor home. In one embodiment, interlocking chocks 106 could be used for safely blocking wheels of the vehicle 104. The interlocking chocks 106 are positioned at the wheels of the vehicle 104.

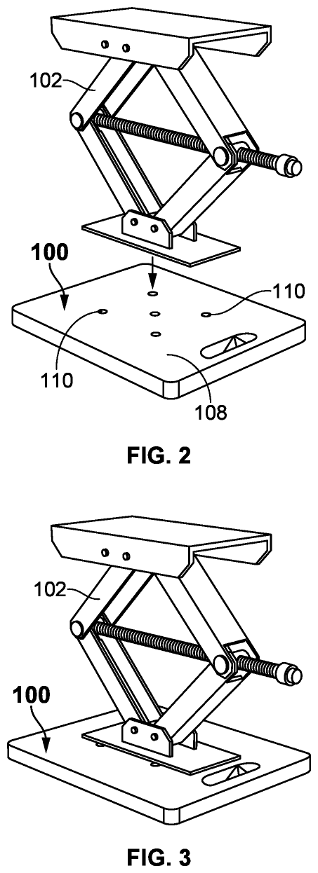

Referring to FIG. 2, the leveling jack 102 is positioning on the magnetized pad 100 is disclosed. In one embodiment, the leveling jack 102 lower portion is securely positioned on a top surface 108 of the magnetized pad 100 and the upper portion is securely attached to the underside of the vehicle 104. The magnetized pad 100 could be used for any type of leveling jacks. In one embodiment, the magnetized pad 100 comprises one or more magnets 110. In one embodiment, the magnets 110 could be embedded into, but not limited to, the top surface 108 of the magnetized pad 100.

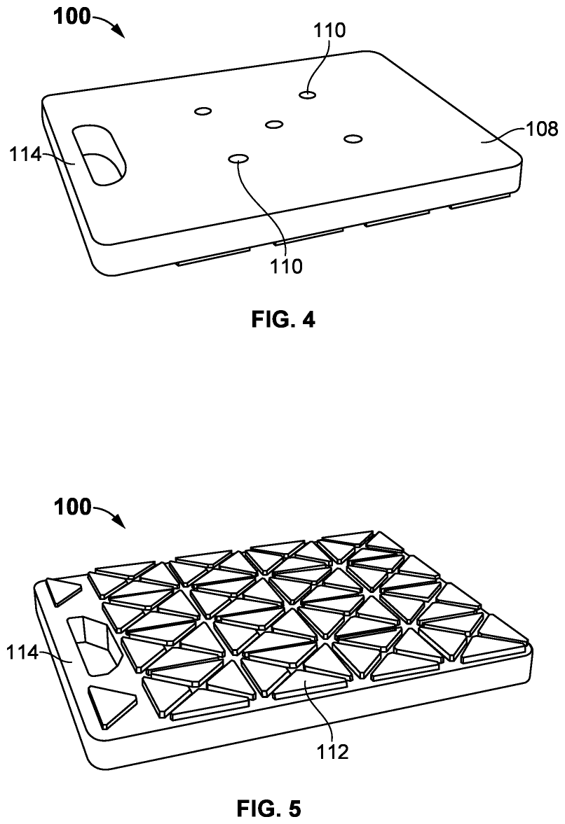

Referring to FIG. 3, the leveling jack 102 is securely positioned on a top surface 108 of the magnetized pad 100 in one embodiment of the present invention is disclosed. The deployment of the magnetized pad 100 is very easy and quick, and prevents the leveling jacks 102 from sinking into soft surfaces or grounds. After use, the jacks 102 are retracted and the magnetized pads 100 are quickly and easily stripped off for storage. The magnetized pads 100 significantly provides a larger footprint for the vehicle's leveling jack foot for leveling and stabilizing the vehicle 104 (shown in FIG. 1), for example, the recreational vehicle. The larger foot (85 square inches) then spreads the leveling forces significantly, providing a stable leveling force that does not change during vehicle movements. Referring to FIG. 4, the magnetized pad 100 provided with one or more magnets 110 is disclosed. In one embodiment, the magnets 110 are securely embedded into the top surface 108 of the magnetized pad 100. The magnets 110 are configured to securely hold the leveling jack 102 (shown in FIG. 2) during operation and the magnetized pad 100 provides a significantly larger footprint for the leveling jack 102 on the vehicle 104. In one embodiment, the magnetized pad 100 could be made of a material, but not limited to, plastic.

In one embodiment, the magnetized pads 100 are machined into 8.5″ (216 mm) by 10.0″ (254 mm) rectangles from a large sheet of 0.75″ (19.05 mm) thick high-density polyethylene (HDPE) plastic in a water jet machining center. These rectangles are then transferred to a CNC machining center, where the upper and lower edges are rounded and one or more pockets 126 (shown in FIG. 12) and handle are machined. After cleaning and drying, the rectangles are subjected to a vibrational deburring operation, cleaned, and then flame treated at the magnet pocket's location. In one embodiment, the pockets 126 could be partially filled with an adhesive 124 (shown in FIG. 12) such as, but not limited to, 2-part epoxy adhesive. After, neodymium magnets are pressed into place. In one embodiment, a protective layer or disk 122 (shown in FIG. 12) is pressed onto the pocket 126 so the upper surface of the disk 122 is level with the top surface 108 of the magnetized pad 100. In one embodiment, the disk 122 is made of, but not limited to, high-density polyethylene plastic. In one embodiment, the protective layer 122 has a thickness of about, but not limited to, 0.010″ (0.254 mm). After curing, any excess glue is scraped off without scarring the pad's upper surface. The protective layer 122 prevents water intrusion into the pockets 126 but is thin enough to not significantly affect the pull strength of the magnets 110. The inexpensive neodymium magnets are rated at 3.8-pound pull at direct contact, with the total pad adherence strength, on a clean leveling jack foot, at about 15 pounds with the thin plastic covers. In one embodiment, at least 4 magnetized pads 100 are packed for shipment in a pre-printed cardboard carton.

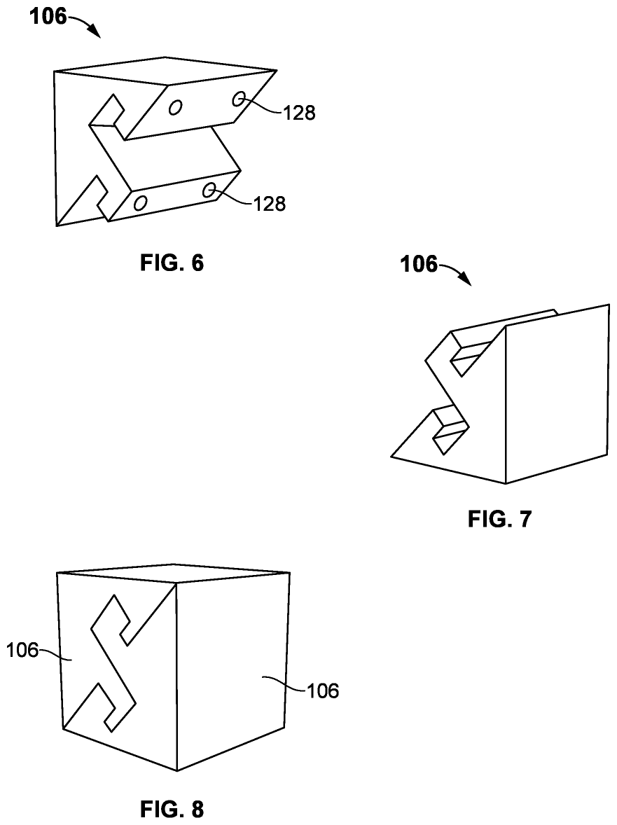

Referring to FIG. 5, a bottom portion of the magnetized pad 100 is disclosed. In one embodiment, the bottom portion of the magnetized pad 100 comprises a bottom surface with a tread-like pattern. In one embodiment, the tread-like pattern includes 0.125″ tall pyramidal pattern on 0.25″ centers, which is fabricated in a CNC milling center when the other machining on the pad is being performed. The bottom surface 112 could prevent the magnetized pad 100 from slipping on smooth surfaces or grounds. In an exemplary embodiment, the magnetized pad 100 could be made of, but not limited to, high-density polyethylene (HDPE) plastic. In some embodiments, the bottom surface 112 of the magnetized pad 100 includes, but not limited to, one or more machined multiple patterns to prevent slippage upon gravel or loose soil surface. Referring to FIGS. 6-7, the interlocking chocks 106 are disclosed. In one embodiment, the interlocking chocks 106 could be positioned at both sides of the vehicle's 104 wheels for safely blocking, thereby avoiding the vehicle 104 from moving on smooth surfaces or grounds and inclined surfaces. In one embodiment, one or more magnets 128 could be embedded on the surface of each interlocking chock 106 for securing the interlocking chocks 106 together as a single block shown in FIG. 8.

Referring to FIG. 8, the interlocking chocks 106 are secured together as a block is disclosed. In one embodiment, the interlocking chocks 106 could be secured together as a block. In one embodiment, one or more magnets 128 (shown in FIG. 6) could be embedded on the interlocking chocks 106 for securing the interlocking chocks 106 together. In some embodiments, the interlocking chocks 106 could be secured together as a single block without using magnets 128. In one embodiment, the interlocking chocks 106 could be used as a magnetized block for added height under the leveling jack 102 or the tongue jack. By attaching the magnetized chock/block 106, the consumer or user could save time, wear, get a bigger footprint, thereby increasing the stability by keeping the leveling jack 100 from being fully extended, or as a block, be placed under the rv tongue jack for increased height. The addition of magnets on the surface of the interlocking chocks 106, would allow this block to be positioned on the leveling jack 102 in the upright position, and then lowered until ground contact giving a unique usage feature and design as well. In one embodiment, the rectangular blocks are magnetized without the interlocking chock feature. These could be hollow, stackable for easy usage and storage when not in use.

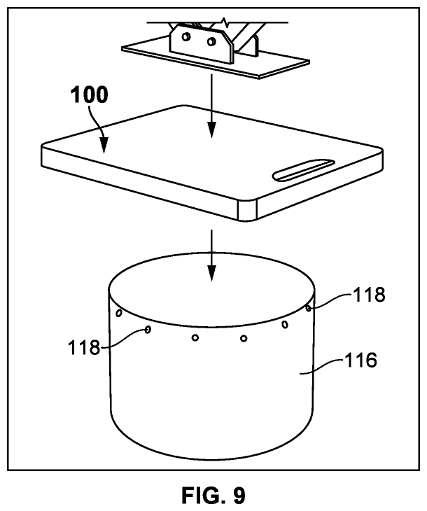

The interlocking chocks 106 could require less space for storing in a place. Referring to FIG. 9, a cylindrical structure 116 used for increasing height of the vehicle 104 at very uneven terrain is disclosed. In one embodiment, the cylindrical structure 116 could be placed at the bottom portion of the magnetized pad 100 to obtain more height in circumstances of very uneven terrain. In one embodiment, the cylindrical structure 116 comprises one or more plurality of light-emitting diodes (LEDs) 118 to provide lighting for the user in low light conditions. In one embodiment, the LEDs 118 could be, but not limited to, pressure sensitive LEDs.

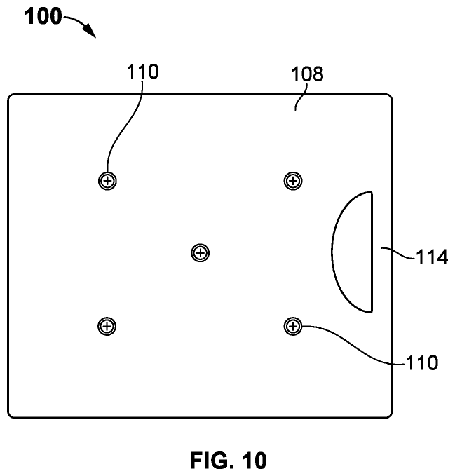

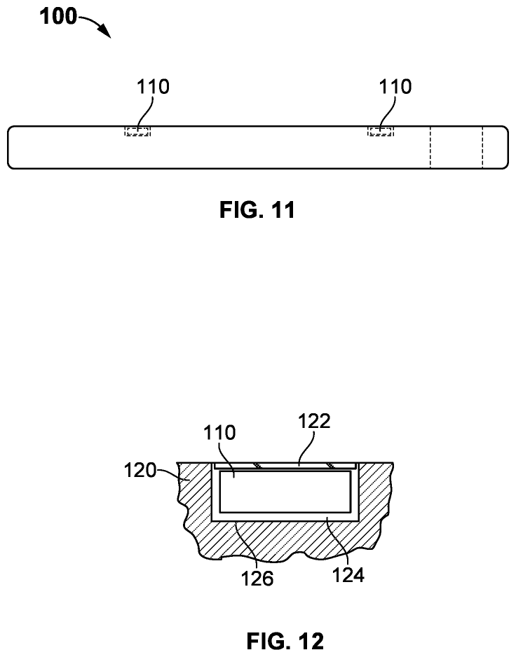

Referring to FIGS. 10-11, a top view and a side view of the magnetized pad 100 are disclosed, respectively. In one embodiment, the magnetized pad 100 is machined from a sheet of, but not limited to, high-density polyethylene (HDPE) plastic that is 0.75″ thick. The plastic is highly resistant to moisture and could withstand the loads imposed by the leveling jacks 102. In one embodiment, each magnetized pad 100 spreads the weight applied by the leveling jacks 102 and spreads the load, thereby reducing the wheels and the vehicle 104, for example, a trailer, from sinking into the ground upon which they are resting so the vehicle 104 remains perfectly level as a set. Even the vehicle moving back and forth due to wind gusts or interior traffic will not drive the magnetized pads 100 deeper into the lot surface. In one embodiment, the magnets 110 are protected from absorbed moisture using a thin layer of plastic without reducing the pull force of the magnets 110. The combined pull force of the magnets 110 holds the magnetized pads 100 onto the steel foot of the leveling jacks 102 and allows them to be easily removed after use. In one embodiment, the outer edges of each magnet 110 could be fitted within, but not limited to, 4.5″ by 5.0″ rectangle.

In one embodiment, each magnet 110 has a diameter of about, but not limited to, 0.3125″ ( 5/16″) and a thickness of about, but not limited to, 0.125″ (⅛″). In one embodiment, the magnets 110 could be adhesively bonded into a deep of about, but not limited to, 0.150″ on the top surface 108 of the magnetized pad 100. In one embodiment, one or more pockets or holes are milled using a CNC milling center using a 21/64″ (0.3281″) end mill by 0.150″ deep. In one embodiment, each magnetized pad 100 comprises a handle or an opening 114. In one embodiment, the handle 114 is inset 0.5″ from the outer edge and 3″ wide by 1″ deep. All corners are radiused so there are no sharp edges and the magnetized pads 100 are easy to handle. After use, the leveling jacks are retracted, the plastic pads are stripped off, and then wiped clean before compact storage within a trailer cubby or tool box. In one embodiment, the magnetized pad 100 could easily be cleaned using, but not limited to, soap and water after use and stack compactly in a trailer cubbyhole between uses. The magnetized pads 100 could easily be washed with soap and water, rinsed, and then dried for storage.

Referring to FIG. 12, a sectional view of the magnetized pad 100 in one embodiment of the present invention is disclosed. In one embodiment, the magnets 110 are securely and adhesively affixed to the plastic body 120 on the top surface 108 of the magnetized pad 100 using, but not limited to, an adhesive 124. In an exemplary embodiment, the magnet 110 could be, but not limited to, strong neodymium magnet. In one embodiment, a protective layer or disk 122 (shown in FIG. 12) is pressed onto the pocket 126 so the upper surface of the disk 122 is level with the top surface 108 of the magnetized pad 100. In one embodiment, the disk 122 is made of, but not limited to, high-density polyethylene plastic. In some embodiments, the disk 122 could be, but not limited to, a thin plastic protective layer.

The magnetized pads 100 are designed to be aesthetic and effective in the application. The relative ease of manufacture and the moderately inexpensive components provide good marketability for the manufacturer. The user benefits from improved leveling and reduced settling over time, which should provide considerable market interest in the product.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1) A device to stabilize and level a vehicle, comprising:
a leveling jack to connect to the vehicle
a magnetized pad configured to connect to the leveling jack; wherein the magnetic pad is configured to provide a larger footprint for the leveling jack to stabilize and level the vehicle.

2) A device to stabilize and level a vehicle as in claim 1, wherein the vehicle is a recreational vehicle (RV).

3) A device to stabilize and level a vehicle as in claim 1, wherein thee bottom surface of the magnetic pad includes a tread surface to provide an increased fictional surface.

4) A device to stabilize and level a vehicle as in claim 1, wherein the vehicle is at least one of a camper, a trailer, a fifth wheel, a toy hauler or a motor home.

5) A device to stabilize and level a vehicle as in claim 1, wherein the device includes a first interlocking chock

6) A device to stabilize and level a vehicle as in claim 5, wherein the first interlocking chock includes a embodied magnet to connect to a second interlocking chock to form a block.

7) A device to stabilize and level a vehicle as in claim 1, wherein the leveling jack includes an upper portion being connected to the underside of the vehicle.

8) A device to stabilize and level a vehicle as in claim 7, wherein the leveling jack includes a lower portion being connected to a top surface of the magnetic pad.

9) A device to stabilize and level a vehicle as in claim 8, wherein the top surface of the magnetic pad is embedded with at least one magnet.

10) A device to stabilize and level a vehicle as in claim 9, wherein the at least one magnet is a neodymium magnet.

11) A device to stabilize and level a vehicle as in claim 9, wherein the magnetic pad includes a pocket to accept the at least one magnet.

12) A device to stabilize and level a vehicle as in claim 11, wherein the pocket includes adhesive.

13) A device to stabilize and level a vehicle as in claim 1, wherein the magnetized pad is formed from high-density polyethylene (HDPE) plastic.

14) A device to stabilize and level a vehicle as in claim 12, wherein the adhesive is a two-part epoxy adhesive.

15) A device to stabilize and level a vehicle as in claim 3, wherein the bottom surface of the magnetized pad includes a multiple pattern tread to prevent slippage.

16) A device to stabilize and level a vehicle as in claim 1, wherein the device includes a cylinder structure to connect to the bottom surface of the magnetic pad to obtain more height for the device.

17) A device to stabilize and level a vehicle as in claim 16, wherein the cylinder structure includes light emitting diodes (LEDs).

18) A device to stabilize and level a vehicle as in claim 17, wherein the light emitting diodes are pressure sensitive light emitting diodes.
